(19) United States
(12) Patent Application Publication
(10) Pub. No.: US 2009/0287931 A1
(43) Pub. Date: Nov. 19, 2009

(54) Establishing Proof of Existence and Possession of Digital Content

(76) Inventor: Cian Kinsella, County Dublin (IE)

Correspondence Address: JACOBSON HOLMAN PLLC, 400 SEVENTH STREET N.W., SUITE 600, WASHINGTON, DC, 20004, US

(21) Appl. No.: 12/086,927

(22) PCT Filed: Dec. 21, 2006
(86) PCT No.: PCT/IE2006/000144

§ 371 Date: Jun. 23, 2008

(51) Int. Cl. H04L 9/32; G06F 15/16

(52) U.S. Cl. 713/175; 709/206

(57) ABSTRACT

A method for establishing proof of existence and possession of source digital content, the method comprising the steps of generating a content certificate by calculating a content hash derived from the source digital content; creating code incorporating the content hash and content details, and a certifying body time-stamping and digitally signing the content hash and the content details to create a content certificate; transmitting the content certificate via a secure channel so that the recipient can verify that the certificate came from the certifying body; transmitting a digitally signed file representing the content certificate content details. A tamper-proof audit trail of certification is generated by: calculating a proving hash of a concatenated file of data relating to a plurality of content certificates; publishing the proving hash, and publishing the concatenated file. Existence of content is proved by: verifying certified digital content against the content certificate using hash verification and checking history of public keys from digital identities; and proving prior existence of the content certificate by reference to published proving hashes and historic content hashes without reference to the certifying body.

### FIELD OF THE INVENTION

The invention relates to proving existence of and possession of digital content such as documents, sound files, or visual images.

### PRIOR ART DISCUSSION

In the last ten years or so there has been considerable progress in the field of data security, particularly for transmission of data between parties. However there is still a need for improved processes for managing content in a secure manner for a variety of applications such as business contracts and copyright material handling.

U.S. 2002/0002543 A1 describes a system and method for online copyright management. This involves submitting digital content to an independent body over the internet, receiving a digitally-signed certificate of copyright, allowing such content to be reviewed by third parties over the Web, and allowing third parties to purchase licences to use such copyrighted material according to limitations and rules defined by the copyright owner.

EP 0940945 A2 describes a system and method whereby a cryptographic hash function is applied to an electronic document to produce a document fingerprint. A second cryptographic hash function is applied to the document fingerprint, a time stamp and a serial number to provide a document certificate fingerprint.

The issue of preserving and proving a document's integrity has been addressed thus far primarily with digital signature technology, whereby a digital signature is embedded into a document, along with a timestamp obtained from a trusted third party. This involves modifying the original content file and a requirement that the user have a digital certificate. Also, security is ultimately dependent on trust of a third party to establish a document's integrity.

Some approaches to the problem rely on embedding a cryptographic token in the content, which is represented visually, for example as a stamp. Such approaches have the disadvantage of altering the content itself, and also such technology is typically limited to work with static, visually represented, files such as word processing documents.

U.S. Pat. No. 7,047,404 (Surety) describes an approach in which a client software application manages multiple content files and obtains digital “seals” from a server (over the internet) which correspond to each file. The content files can be verified against the corresponding seals in a process which again refers back to a server. It appears that because this requires use of a proprietary software application the seal files are proprietary and can only be interpreted by purpose-designed software, and because there is no mechanism to prevent tampering at the server side such systems are highly dependent on trust of third parties.

The invention is directed towards providing an improved system and method for proving the historic integrity of content.

### SUMMARY OF THE INVENTION

According to the invention, proof of possession of digital content is established in a method comprising certifing a hash value derived from the content. The hash value may be embedded in a certificate of possession, despatch, or delivery, and the certificate may be time stamped and digitally signed.

According to another aspect, there is provided a method for establishing proof of existence and possession of source digital content, the method comprising the steps of:
generating a content certificate by:
a. calculating a content hash derived from the source digital content,
b. creating code incorporating the content hash and content details, and a system hosted by a certifying body time-stamping and digitally signing the content hash and the content details to create a content certificate,
c. transmitting to a recipient the content certificate via a secure channel, and
d. recording the content certificate in a database, creating an unalterable audit trail of certification, by:
e. calculating a proving hash of a concatenated file of data relating to a plurality of content certificates,
f. publishing the proving hash, and
g. retaining the concatenated file,
proving existence of content, by:
h. verifyng the certified digital content against the content certificate and checking the public key from the digital certificate against a known public key for the certifying body, and
i. proving prior existence of the content certificate by reference to the concatenated file of step (e), calculating the hash of this file, and comparing this with the proving hash as published in step (f)

In one embodiment, steps (e), f) and g) are repeated at regular proving periods.

Step (e) may comprises calculating a proving hash of a file of concatenated content hashes, or alternatively calculating a proving hash of a file of concatenated content certificates.

In one embodiment, the time stamp is provided by a secure time stamp server.

In one embodiment, the content certificate is saved to a secure database associated with a certifying body.

In one embodiment, the content certificate is embedded into the source digital content; and wherein a space in the source digital content adequate to contain the content certificate outside of the limits of the content and integral structure of a source digital content file is filled with fixed known data before the calculation of the hash at step (a), and subsequently in step (d) the content certificate file is appended to said file in that location, and the file is extended in size if necessary, so that an application for reading the file does not read the content differently.

In one embodiment, the method is implemented by a client computer and the certifying body system is a server for the client computer. The client computer may use only a browser and an application for reading the source digital content.

In one embodiment, step (a) is performed by the client computer and the calculated hash is transmitted to the server, but the source digital content is never transmitted to the server.

In one embodiment, step (a) is performed by a downloaded program executing within a standard browser.

In one embodiment, step (a) is performed by an offline computer, and the hash is inputted to the client computer, so that the source digital content need not be stored or processed on the client computer.

In one embodiment, the client computer automatically interfaces with the server without user intervention, and the client computer may execute an API to interface with the server.

In one embodiment, the method comprises the further steps of a verification program inspecting a source digital content file, identifying certificate data in said file and substituting it with the fixed known values before calculating the hash for comparison purposes.

In one embodiment, step (i) comprises verifying the prior existence of a content certificate in its full text by reference to an historic file of concatenated certificates and the relevant published proving hash.

In one embodiment, the content certificate is transmitted in step (c) together with an explanatory message.

In one embodiment, the content certificate is emailed to the user in step (c) and in parallel a confirmation is displayed on a user's browser.

In one embodiment, the content is forwarded by email or digitally signed email to a nominated third party.

In one embodiment, the certifying body sends a digitally signed email to a user certifying that the content has been forwarded to a nominated third party. Preferably, if proof of delivery to nominated third party address is obtained, the certifying body sends a digitally signed email to a user certifying this delivery and providing details.

In one embodiment, the content is printed or copied to physical medium and delivered by registered delivery to a nominated third party.

In one embodiment, a message transmitting the content to a nominated third party does not contain the content itself, but instead an internet hyperlink to a download location. Preferably, following the download of content arising from an email with an internet hyperlink to that content, the certifying body sends a digitally signed email to user certifying that such download had taken place with details.

In one embodiment, a read receipt is obtained from the recipient of email sent to a nominated third party and the certifying body sends a digitally signed email to a user certifying that such a read receipt had been obtained.

In one embodiment, the content certificate is transmitted in step (c) via digitally signed email

In one embodiment, the code of step (d) is in a mark-up language such as XML.

In one embodiment, the proving hash is published in a paper medium.

In one embodiment, step (h) comprises verifying the certified digital content against the content certificate by calculating the hash of the content and comparing that with the content hash embedded in the content certificate.

In one embodiment, wherein step (i) comprises proving prior existence of the content certificate by reference to published proving hashes and published historic concatenated files of content hashes without reference to a certifying body.

In one embodiment, step (i) incorporates checking the public key from the digital certificate against a list of known public keys for the certifying body.

In another aspect, the invention provides certifying body system for performing certifying body system operations of any method as defined above.

The invention also provides a computer readable medium comprising software code for implementing the steps of any method as defined above when executing on a digital processor.

### DETAILED DESCRIPTION OF THE INVENTION

### BRIEF DESCRIPTION OF THE DRAWINGS

The invention will be more clearly understood from the following description of some embodiments thereof, given by way of example only with reference to the accompanying drawings in which:—

FIGS. 1 is a flow diagram of operations for establishing proof of possession of content via an internet browser, and FIG. 2 shows a variation whereby in addition to establishing proof of content via an internet browser, the content file is uploaded for onward despatch to a third party with independent representation of this;

FIG. 3 is flow diagram for a process which differs from that of FIG. 1 in that the certifying process is initiated from within an editing application (e.g. Microsoft Word) rather than a browser on the client PC;

FIG. 4 is a flow diagram of operations for certifying a previously-calculated hash; and

FIG. 5 is a flow diagram of operations for a regular periodic (e.g. daily) proving run.

FIG. 6 is a flow diagram of operations for verifying the prior existence of certified content and the authenticity of the certificate itself.

### DESCRIPTION OF THE EMBODIMENTS

### Overview

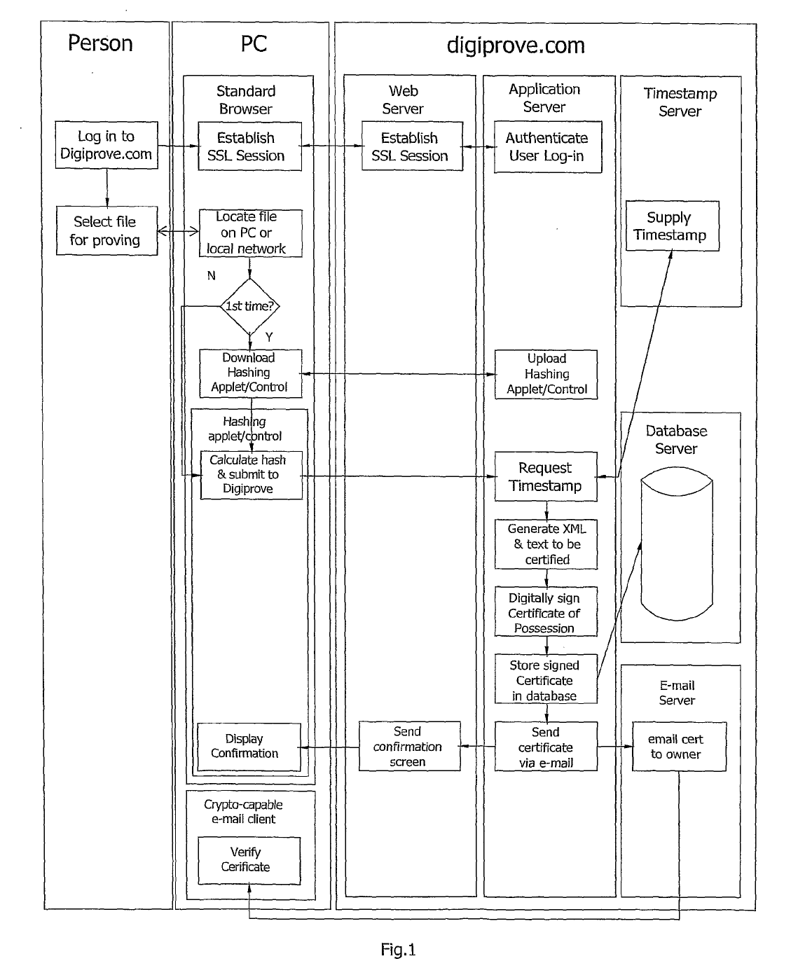

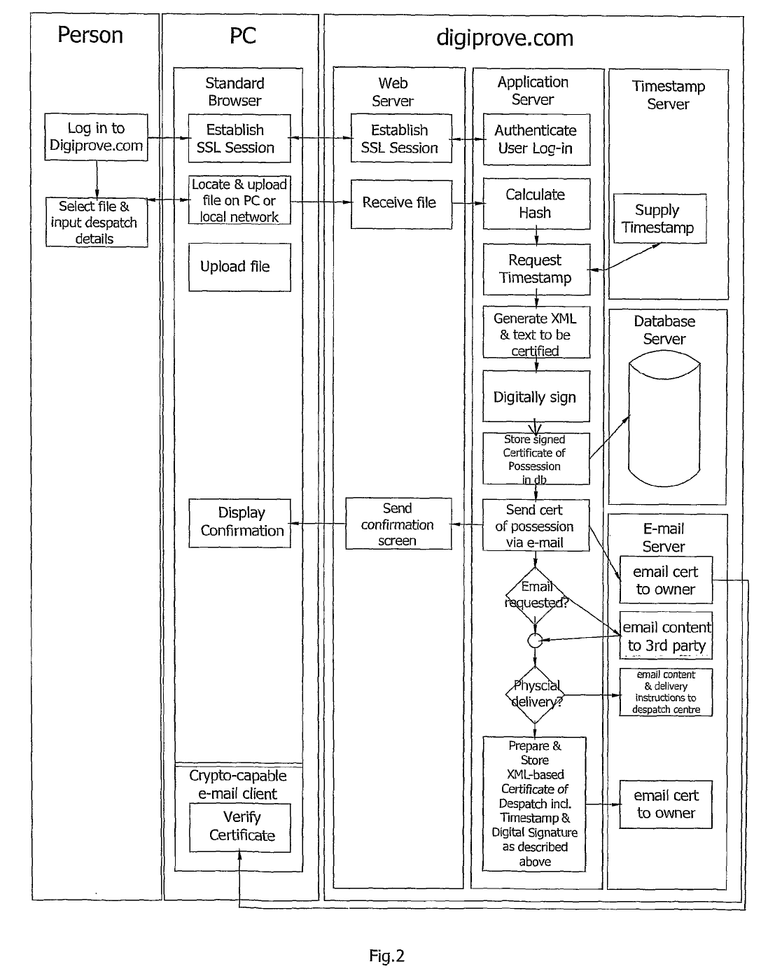

Referring to FIG. 1 a system and method for establishing proof of possession and existence of digital content is illustrated. A client computer executes a browser and logs onto the Digiprove Web site in an SSL session. The relevant digital content is located locally and a downloaded hashing Applet is executed to generate a content hash, and this is submitted to the Digiprove server. The server retrieves a time stamp from a time stamp server and generates an XML document with the hash, the time stamp, and descriptive text. This is digitally signed to provide a content certificate, called a “Digiprove Certificate”. The Digiprove Certificate is stored in a secure database and is sent via secure email to the client computer at the same time as details being displayed on the client computer browser. The certificate received via secure email is verified by a cryptographic application on the client computer. This authenticates the sender by reference to an X509 digital certificate and the integrity of the message by use of a cryptographic message digest.

FIG. 2 shows a variation in which the content file is uploaded to the server and the hash is generated on the server. This variation also involves emailing the content file to a nominated third party or physically delivering the content in printed or digital media form to the nominated third party. In this embodiment, there is transmission of the content from the client computer to the server, which may be perceived as a disadvantage. However, on the other hand there is no need for the client to download a hash-generating program and also the server can provide the additional service of sending the content to a nominated third party.

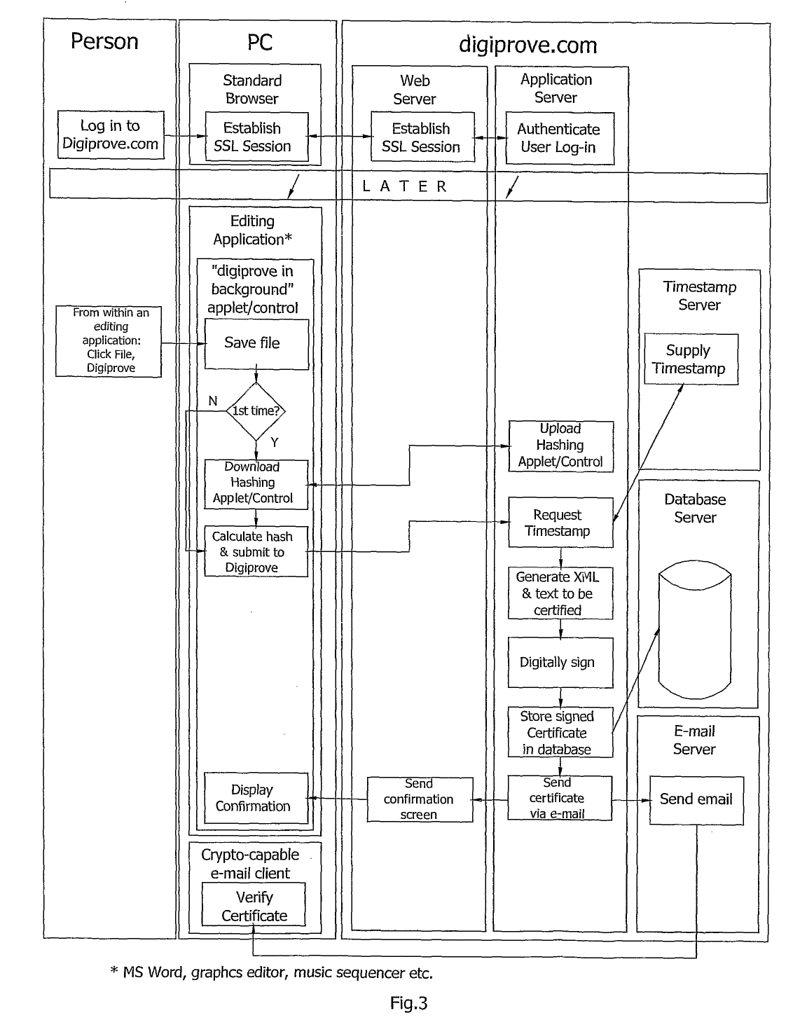

FIG. 3 shows a variation in which a Digiprove applet executes in the background in a client computer application to allow simple user selection of the process. As in FIG. 1, the content is not transmitted to the server.

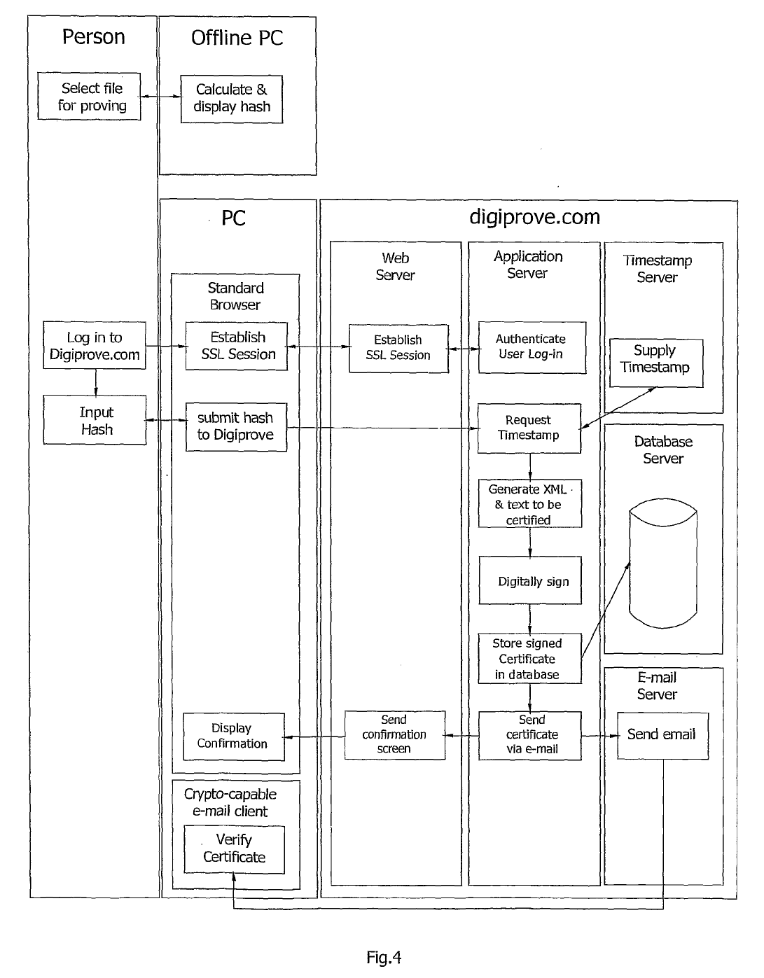

FIG. 4 illustrates a variation in which the hash is generated offline (on the client computer or a different computer) and is transmitted by the client computer to the server. In this case, neither the client computer nor the server handles the content. In this embodiment, the owner of the content can be absolutely sure of privacy of the content because it has not been handled by any of the computers during communication over the internet.

A certifying body (referred to herein as “Digiprove”) hosts the server to offer the certifying process over the internet to owners of digital content. The method certifies the hash value mathematically derived from the digital content itself. This value is embedded in the content certificate of possession which is then time-stamped and digitally signed by a “Digiprove” server before being returned to the owner. This avoids need for the digital content itself to be submitted.

The description below makes reference to a “Digiprove Certificate”. This is a content certificate of possession, despatch, or delivery of digital content, and is not to be confused with the general term “Digital Certificate”, being a certificate of identity in “x509” form which is a basic building block of many internet security implementations.

The Digiprove Certificate is transmitted in an S/Mime format with embedded XML content, allowing programmatic access to the content, as well as human-readable display and verification through a standard email client.

The method allows users to prove compliance with corporate and financial law and regulation, to fairly protect themselves in potential future litigation or criminal proceedings. It can also be used to prove despatch and delivery of information to third parties, again to prove compliance or to protect against future litigation. It also has a role in helping people to establish ownership of some intellectual property such as copyright. Other applications include taking of witness statements or other situations where proof of existence and possession of a document or other content is important. Another example is where a video file is generated to prove a residence inventory at a certain time.

The method permits the date of issue of a Digiprove Certificate to be subsequently proven by publishing on a regular basis a hash of aggregated such certificates for a period.

The method allows a person to obtain independent certification and proof that he or she is in possession of a file of digital content at a point of time, without revealing its contents to the certifier or any third party, for use in a wide variety of legal, compliance and content management applications. Such digital content, once possession has been certified, can be despatched and delivered to third parties and such despatch and delivery can be independently certified. Also, the method makes forgery of Digiprove Certificates almost impossible. This method uses a sequence of steps including the use of some cryptographic algorithms already proven and in use in internet e-commerce and elsewhere.

### The “Digiprove” Processes

### User Registration

Each user must register in order to use the service. The registration only happens once and has three steps:

a. User submits personal data

b. User selects membership or subscription type (and makes payment if necessary)

c. An activation process takes place, such as the e-mailing of an activation code and associated hyperlink for user to action.

### Issuing a Digiprove Certificate (FIGS. 1, 2, 3, 4)

Each time a user wants to have a digital content file “Digiproved”, the following steps are implemented:

### Log-on

The user inputs his User ID and password. He can choose to remain logged on to Digiprove as long as he is logged onto the computer, thus facilitating repeated usage during the session.

### Selection of File to be “Digiproved”

The user can select a file to be “Digiproved” (the “content file”) in one of two ways:
While viewing the Digiprove web-site, he can browse his computer or local network and select the file. Optionally, if the user grants to a downloaded applet write access to his local file system, the content file will then be marked as read-only, or copied as a read-only file into a nominated folder (e.g. “My Documents/My Digiprove Documents”) of the current user, as shown in FIG. 1
As shown in FIG. 2, while editing the file from within an application on the client computer (any content editor such as word processors, image editors, sound editors), he can select “Digiprove” from the file menu. He is required in this case to be already logged on to Digiprove from earlier. This will cause the file to be saved to the nominated folder of the current user, and the process will continue in the background from there.

### Optional Submission of File

The user may decide to submit the original content file to Digiprove (FIG. 2) for one or more of the following:
Calculation of hash at central server rather than locally on the client computer.
Safekeeping of the source content at Digiprove's secure location.
For Digiprove to despatch the content file to a named 3^{rd} party, either by e-mail or physically, or both, and to certify such despatch and subsequently to certify any recorded delivery. In this case, the addressee details are also submitted over the Web.

### Calculate/Submit Hash

This step does not apply if the user is uploading the entire file. If the user uploads the entire file, the calculation of the hash will be done on the server (FIG. 2) and no applets will need to be used.

An ActiveX (or alternatively Java applet) will run (and be downloaded if not cached from a previous session). This calculates a hash of the file using the “SHA1” algorithm (or another such hashing algorithm in alternative embodiments), and passing this hash to Digiprove while displaying a message such as:
“SHA1 hash of file [Filename and Location] is:
XX-XX-XX-XX-XX-XX-XX-XX-XX-XX-XX-XX-XX-XX-XX-XX-XX-XX-XX.
Enter optional file description now. To submit this hash to Digiprove.com for certification press “submit” button.”
The language of this text may be the preferred language of the registered user.

### Advanced User Option

Referring to FIG. 4, instead of the foregoing three steps, an advanced user can choose to simply input the hash value which he has calculated separately on the file (perhaps on a separate offline computer) along with the file name and description.

Integration with Other Software Systems

To facilitate the easy use of the Digiprove methodology to prove the possession and existence of programmatically produced or administered content without user intervention (e.g. financial audit trails, incoming and outgoing emails), it will also be possible to interact with the Digiprove service via defined APIs (Application Program Interfaces) using a secure protocol which can be used to replace the foregoing steps (from “Log-on”) with the following steps:
Programmatic Log-on
Supply and Verification of User ID and Password. Creates a session for repeated submission of file details until log-out.
Submission of File Details
Supply of filename, hash (calculated by the other software system), and description. These are all the details required to be incorporated in a certificate of possession.

The API protocol may permit the submission of batches of content to facilitate multiple certificates. In all cases the protocols to be used for the API will employ widely accepted cryptographic techniques to assure authentication of both parties, privacy (encryption), and integrity of data.

The API protocols will be published to authorised users of the service.

### Create Digiprove Certificate

The following process is performed from the server location:
Read current time from a secure clock
Create XHTML, XML, or plain text containing a standard text such as:
   “Digiprove certifies that User ID x - - - x, (Name of Submitter) was in possession of the file “Original filename” described below in digital form on the dd mmmmmmmmm yyyy hh:mm:ss UTC. [either:] A copy of “Original Filename” has been retained by Digiprove. [or:] Please retain the original file “Original Filename” safely for your records. To prove the veracity of this certificate and to verify its match to the associated file you can use the program “verify-digiprove-certificate.exe” available at www.digiprove.com/downloads/verify-digiprove-affidavit.exe. Any change to the original file will be detected by the verification program.”
   Digiprove serial number (of this certificate)
   Original file name
   Timestamp (in UTC)
   File hash
   Description of file
   Name of submitter

Display the above text on the user's computer along with the text “A digitally-signed Digiprove Certificate in the following form is being sent to your email address”

Send a digitally-signed email in S-mime format with the above text to the submitter. This is the Digiprove certificate. Attached to the email will be a file containing the same information in XML format, to facilitate programmatic verification; this file will itself be digitally signed. This is the Digiprove Certificate file. The format of this file conforms to a widely used standard called PKCS7
Save and retain the Digiprove Certificate as a file.

### Despatch and Delivery

If the user has chosen to upload the content file for the purposes of despatch to a nominated 3^{rd} party of the content file by recorded delivery, in addition to providing a certificate of possession, the system will generate a certificate of despatch in similar form to the above (i.e. incorporating a hash, time-stamped and digitally signed) adding in details of despatch (method and addressee). Subsequently on receipt of any record of delivery (e.g. when using registered post or courier services), a Certificate of Delivery in similar form will be formulated and sent to the user, incorporating details of delivery acceptance, and potentially including a scanned image of receipt document(s).

### Appending a Digiprove Certificate File to Content File

At the option of the user, the Digiprove Certificate file which was attached to the emailed certificate can be physically appended to the content file. The effect of this is that the content file may be extended in size to accommodate the extra information, although in some cases it will fit within the unused space in the file. Whenever the content file is copied or transmitted (e.g. via email), it will contain this embedded data. Because it is placed after the end of the raw content, the content itself is not disturbed in any way, and this additional data will be ignored by editing and display programs. Thus, as long as the content file is not altered the certificate can travel with it.

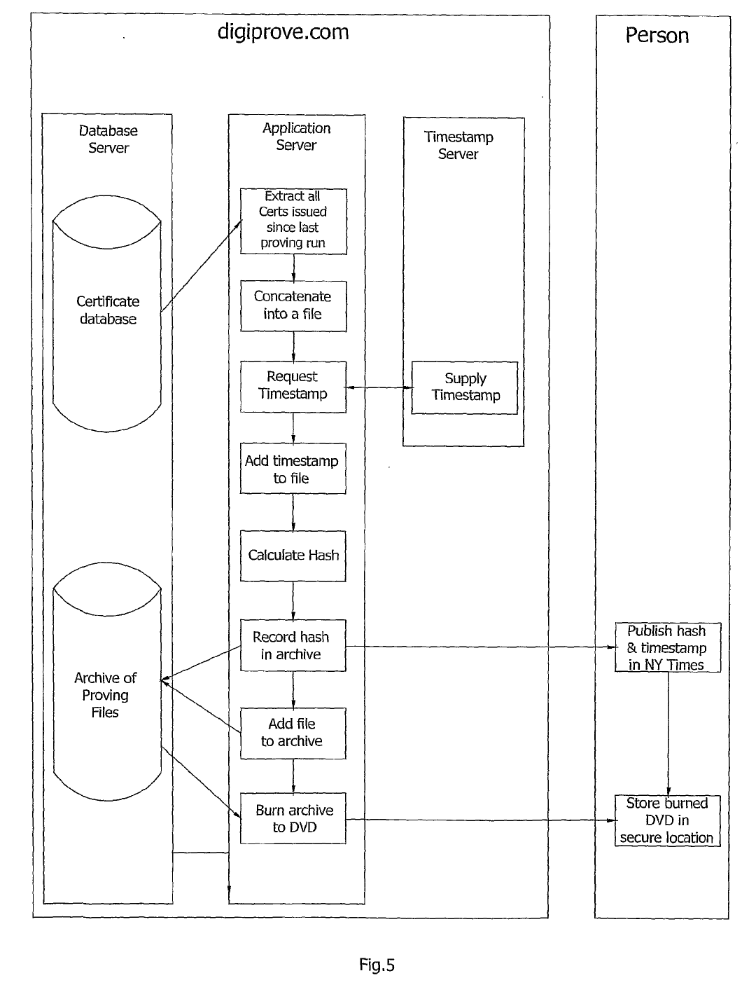

### Proving the Digiprove Certificates (FIG. 5)

A proving process guarantees that a Digiprove Certificate has not been forged or created after the fact, either by an outside party or by Digiprove itself. Referring to FIG. 5, on a periodic basis, all the Digiprove certificates for that period are concatenated into one bulk file (which is retained), and a hash of that file (the Proving Hash) is calculated and published in a printed medium such as a reputable newspaper (any publication that is archived in a public library).

This creates an unalterable audit trail which can be examined independently to prove the integrity of the Digiprove Certificate. To validate that a given Digiprove Certificate an independent inspector will:

a. Obtain a copy of the bulk file described above from Digiprove.

b. Examine the bulk file to ensure that it contains the Digiprove Certificate in question.

c. Calculate the hash of the bulk file

d. Verify that the hash conforms to the Proving Hash as published in the chosen newspaper, as archived in public library.

In a variation of the above steps, on a periodic basis, all the hashes of Digiproved content files for that period are concatenated into one bulk file, which is published on one or more independently hosted web-sites for long-term availability, and a hash of that file (the Proving Hash) is calculated and published in a reputable newspaper.

This creates an unalterable audit trail which can be examined independently to prove the integrity of the Digiprove Certificate. To validate that a given Digiprove certificate existed at the given date, an independent inspector will:

a. download the relevant bulk file of hashes from the Web,

b. examine that bulk file to ensure that it contains the hash contained in the certificate in question,

c. calculate the hash of the bulk file, and

d. verify that the hash conforms to the Proving Hash as published in the chosen newspaper, as archived in a public library.

In a further variation of either of the above proving methods, the Proving Hash for the previous period is also published along with the current Proving Hash to demonstrate continuity of the audit trail.

### Verifying a Digiprove Certificate

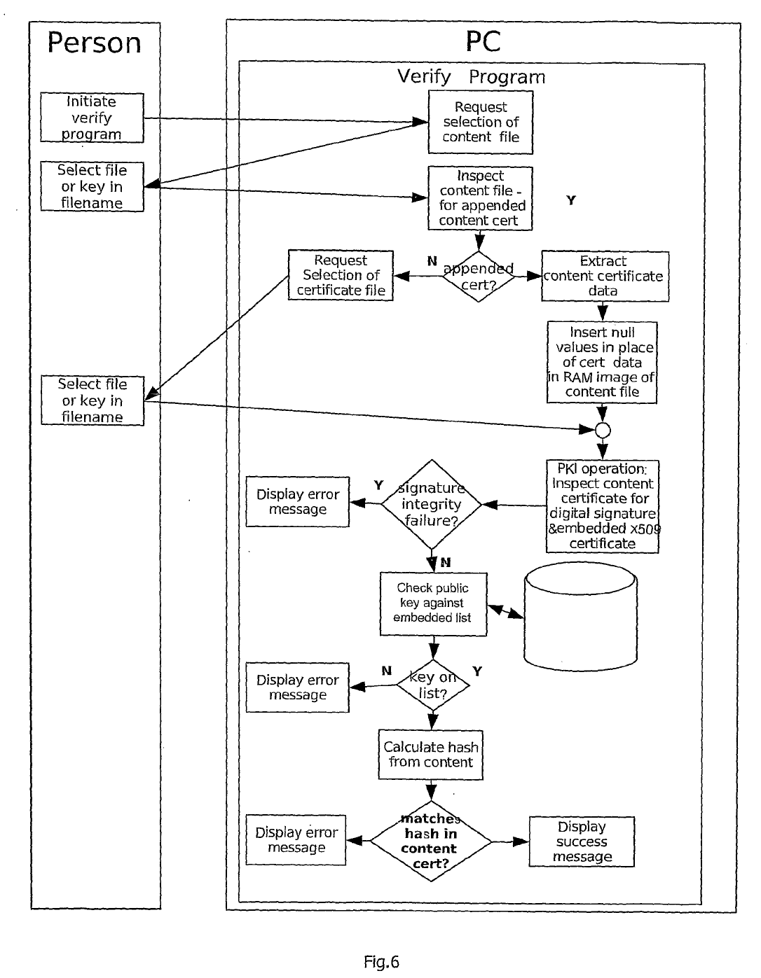

To verify a Digiprove certificate a program is run which is made freely available. This has two functions, as set out in FIG. 6:

It verifies that the digital signature of a Digiprove Certificate is valid, i.e.:
use the public key in the embedded x509 digital cert to verify that the digital signature corresponds to all the details of the Digiprove Certificate, including the date/time and the file hash—fatal failure if this does not match. Note—most e-mail clients, including Microsoft Outlook will already have verified this on receipt of the message.
compare the public key in the digital cert to the list of known public keys for Digiprove to that contained in the X509 digital certificate. There will be a serious warning condition if this does not match.

Secondly it verifies that a given file is the one certified by the Digiprove Certificate by calculating the hash of the content file and comparing that to the hash embedded in the Digiprove certificate.

This verification program will work equally when it is given two files (the content file and the Digiprove certificate file), or one file (the content file with the Digiprove certificate file appended to it).

This verification program will be freely available over the internet and its source code will be published as Open Source and the object code version will be digitally signed by Digiprove.

This verification process will typically be used by the content owner or a third party if he wishes to verify that a content file had been correctly Digiproved and the time.

For advanced users, also available from Digiprove will be a program to calculate and display the hash of a given file.

It will be appreciated that the invention provides a method having the following advantages.
It does not rely on trust in the certifying body (i.e. certificates can not be forged or back-dated, and certification can be verified without reference to certifying body, even after the certifying body ceases to exist.
It can be easily invoked from a Web browser on any computer without use of a separate application
It can also be invoked from within a client application
It can work with all types of content
It does not reveal content to Digiprove (in the embodiments of FIGS. 1 and 3) or any third party (and can be shown not to do this)
Content is not altered in any way
Without the content being altered, a certified content file is identifiable as such and is easily verifiable against the Digiprove Certificate
Certificates are delivered via a separate channel (secure email)
Works with industry-standard data formats and encryption algorithms
Does not require user to obtain and install a digital certificate
One can forward certified content independently to third parties
It keeps a central audit trail of issued certificates

The invention is not limited to the embodiments described but may be varied in construction and detail.

1-33. (canceled)

34. A method for establishing proof of existence and possession of source digital content, the method comprising the steps of:
generating a content certificate by:
a. calculating a content hash derived from the source digital content,
b. creating code incorporating the content hash and content details, and a system hosted by a certifying body time-stamping and digitally signing the content hash and the content details to create a content certificate,
c. transmitting to a recipient the content certificate via a secure channel, and
d. recording the content certificate in a database, creating an unalterable audit trail of certification, by:
e. calculating a proving hash of a concatenated file of data relating to a plurality of content certificates,
f. publishing the proving hash in a paper medium, and
g. retaining the concatenated file, proving existence of content by:
h. verifying the certified source digital content against the content certificate by calculating the hash of the source digital content and comparing that hash to the hash embedded in the content certificate, and checking the public key from the digital certificate against a list of known public keys for the certifying body, and
i. proving prior existence of the content certificate by reference to the concatenated file of step (e), calculating a hash of this file, and comparing said hash with the proving hash as published in step (f).

35. The method as claimed in claim 34, wherein steps (e), f) and (g) are repeated at regular proving periods.

36. The method as claimed in claim 34, wherein step (e) comprises calculating a proving hash of a file of concatenated content hashes.

37. The method as claimed in claim 34, wherein step (e) comprises calculating a proving hash of a file of concatenated content certificates.

38. The method as claimed in claim 34, wherein the time stamp is provided by a secure time stamp server.

39. The method as claimed in claim 34, wherein the content certificate is saved to a secure database associated with a certifying body.

40. The method as claimed in claim 34, wherein the content certificate is embedded into the source digital content; and wherein a space in the source digital content adequate to contain the content certificate outside of the limits of the content and integral structure of a source digital content file is filled with fixed known data before the calculation of the hash at step (a), and subsequently in step (d) the content certificate file is appended to said file in that location, and the file is extended in size if necessary, so that an application for reading the file does not read the content differently.

41. The method as claimed in claim 34, wherein the method is implemented by a client computer and the certifying body system is a server for the client computer.

42. The method as claimed in claim 41, wherein the client computer uses only a browser and an application for reading the source digital content.

43. The method as claimed in claim 41, wherein step (a) is performed by the client computer and the calculated hash is transmitted to the server, but the source digital content is never transmitted to the server.

44. The method as claimed in claim 43, wherein step (a) is performed by a downloaded program executing within a standard browser.

45. The method as described in claim 34, wherein step (a) is performed by an offline computer, and the hash is inputted to the client computer, so that the source digital content need not be stored or processed on the client computer.

46. The method as claimed in claim 41, wherein the client computer automatically interfaces with the server without user intervention.

47. The method as claimed in claim 46, wherein the client computer executes an API to interface with the server.

48. The method as claimed in claim 34, comprising the further steps of a verification program inspecting a source digital content file, identifying certificate data in said file and substituting it with the fixed known values before calculating the hash for comparison purposes.

49. The method as claimed in claim 34, wherein step (i) comprises verifying the prior existence of a content certificate in its full text by reference to an historic file of concatenated certificates and the relevant published proving hash.

50. The method as claimed in claim 34, wherein the content certificate is transmitted in step (c) together with an explanatory message.

51. The method as claimed in claim 34, wherein the content certificate is emailed to the user in step (c) and in parallel a confirmation is displayed on a user's browser.

52. The method as claimed in claim 34, wherein the content is forwarded by email or digitally signed email to a nominated third party.

53. The method as claimed in claim 52, wherein the certifying body sends a digitally signed email to a user certifying that the content has been forwarded to a nominated third party.

54. The method as claimed in claim 53, wherein if proof of delivery to nominated third party address is obtained, the certifying body sends a digitally signed email to a user certifying this delivery and providing details.

55. The method as claimed in claim 34, wherein the content is printed or copied to physical medium and delivered by registered delivery to a nominated third party.

56. The method as claimed in claim 52, wherein a message transmitting the content to a nominated third party does not contain the content itself, but instead an internet hyperlink to a download location.

57. The method as claimed in claim 56, wherein following the download of content arising from an email with an internet hyperlink to that content, the certifying body sends a digitally signed email to user certifying that such download had taken place with details.

58. The method as claimed in claim 34, wherein a read receipt is obtained from the recipient of email sent to a nominated third party and the certifying body sends a digitally signed email to a user certifying that such a read receipt had been obtained.

59. The method as claimed in claim 34, wherein the content certificate is transmitted in step (c) via digitally signed email.

60. The method as claimed in claim 34, wherein the code of step (d) is in a mark-up language such as XML.

61. The method as claimed in claim 34, wherein step (h) comprises verifying the certified digital content against the content certificate by calculating the hash of the content and comparing that with the content hash embedded in the content certificate.

62. The method as claimed in claim 34, wherein step (i) comprises proving prior existence of the content certificate by reference to published proving hashes and published historic concatenated files of content hashes without reference to a certifying body.

63. The certifying body system for performing certifying body system operations of a method as claimed in claim 34.

64. The computer readable medium comprising software code for implementing the steps of a method of claim 34 when executing on a digital processor.
